(19) United States
(12) Patent Application Publication
(10) Pub. No.: US 2014/0241720 A1
(43) Pub. Date: Aug. 28, 2014

(54) LATCHING OPTICAL SWITCH AND SUBSYSTEM USING BISTABLE LIQUID CRYSTAL

(71) Applicant: NEC Laboratories America, Inc., Princeton, NJ (US)

(72) Inventors: Philip Nan Ji, Plainsboro, NJ (US); Ting Wang, West Windsor, NJ (US); Ryuji Aida, Tokyo (JP)

(73) Assignee: NEC Laboratories America, Inc., Princeton, NJ (US)

(21) Appl. No.: 14/188,671

(22) Filed: Feb. 24, 2014

Related U.S. Application Data
(60) Provisional application No. 61/767,899, filed on Feb. 22, 2013.

(51) Int. Cl. H04Q 11/00

(52) U.S. Cl. CPC H04Q 11/0066; H04Q 2201/804; H04Q 2213/013; H04Q 2213/13003; H04Q 2213/1301
USPC 398/50

(57) ABSTRACT

A submarine network includes a submarine network with a branching unit BU for splitting or combining a signal between a main trunk path and a branch path for allowing signals from different paths to share a same fiber optic path, said BU and submarine network normally having a fixed and predetermined wavelength arrangement preventing reconfigurability of the submarine network, and a latching wavelength selective switch WSS or wavelength blocker WB in the branching unit for splitting or combining the signals between the main trunk path and branch path to enable a latching capability and enable reconfigurability of the branching unit BU, the latching WSSS being a bistable liquid crystal based material without moving parts for increased stability and lower power consumption over use of conventional mono-stable liquid crystal LC switches in a submarine network.

### RELATED APPLICATION INFORMATION

This application claims priority to provisional application No. 61/767,899, entitled “Bistable Liquid Crystal-Based Latching Optical Switches”, filed Feb. 22, 2013, the contents thereof are incorporated herein by reference.

### BACKGROUND OF THE INVENTION

The present invention relates generally to OPTICS, and more particularly, to a latching optical switch and subsystem using bistable liquid crystal.

The following prior documents referenced in the application are discussed, not material to patentability of the claimed invention, nevertheless provide additional information.
[1] P. N. Ji and Y. Aono, “Colorless and directionless multi-degree reconfigurable optical add/drop multiplexers”, Proceedings of WOCC 2010, paper OA2, 2010, Shanghai, China.
[2] T. Wang, P. N. Ji, and Y. Aono, “Colorless and directionless multi-degree reconfigurable optical add/drop multiplexers for 100G network application”, Proceedings of SPIE, Vol. 7960, paper 7960-24, 2011.
[3] P. N. Ji, T. Wang, et al., “ROADM for metro DWDM network using wavelength selective devices”, Proceedings of ATFO 2004, pp. 139-150, 2004, Chongqing, China.
[4] G. Baxter, S. Frisken, et al., “Highly programmable Wavelength Selective Switch based on Liquid Crystal on Silicon switching elements,” Proceedings of OFC/NFOEC 2006, paper OTuF2, 2006.
[5] J. Kelly, “Application of Liquid Crystal Technology to Telecommunication Devices”, Proceedings of OFC/NFOEC 2007, paper NThE1, 2007.
[6] “A Performance Comparison of WSS Switch Engine Technologies”, JDSU White Paper, 2009.
[7] B. Fitzhenry-Ritz, “Optical Properties of Electrophoretic Image Displays”, IEEE Transactions on Electron Devices, Vol. ED-28, No. 6, pp. 726-735, 1981.
[9] W.-C. Kao, “Electrophoretic Display Controller Integrated With Real-Time Halftoning and Partial Region Update”, Journal of Display Technology, Vol. 6, No. 1, pp. 36-44, 2010.
[9] D.-K. Yang, J. L. West, et al., “Control of reflectivity and bistability in displays using cholesteric liquid crystals”, Journal of Applied Physics, Vol. 76, No. 5, pp. 1331-1333, 1994.
[10] D.-K. Yang, “Flexible Bistable Cholesteric Reflective Display”, Journal of Display Technology, Vol. 2, No. 1, pp. 32-27, 2006.
[11] T.-H. Lin, H.-C. Jau, et al., “Photoaddressable bistable reflective liquid crystal display”, Applied Physics Letters, Vol. 89, No. 2, paper 021116, 2006.
[12] C.-T. Wang, H.-C. Jau, and T.-H. Lin, “Optically controllable bistable reflective liquid crystal display”, Optics Letters, Vol. 37, No. 12, pp. 2370-2372, 2012.
[13] J. Ma, L. Shi, and D.-K. Yang, “Bistable Polymer Stabilized Cholesteric Texture Light Shutter”, Applied Physics Express, Vol. 3, pp. 021702-021704, 2010.
[14] D.-K. Yang, “Bistable Liquid Crystal Optical Switch”, technology report for NEC, internal, 2011.
[15] “InfoVue™ Bi-Stable LCD Technology”, product information, available online at http://www.lumex.com/images/Lumex_Bi-Stable_LCDtechnology.pdf Lumex, 2010.

Optical switch is an important device in fiber optic communication system. It allows the user to direct the input optical beam to different output ports dynamically. A type of optical switch is latching switch. Latching means that the switching state can be maintained without requiring constant electrical power. In other words, even after the power is turned off or cut, the input optical beam still reaches the targeted output port. This is an important feature in some applications. In particular, this is essential in submarine switching node, such as a branching unit (BU).

A submarine BU is a network element/subsystem in submarine network that splits the optical signal between the main trunk and the branch path and vice versa. This allows the signals from different paths to share the same fiber, instead of installing dedicate fiber pairs for each link. BU has the similar function as the optical add/drop multiplexer (OADM) in the terrestrial WDM networks. Conventional BU and the submarine network have fixed, pre-determined wavelength arrangement, therefore no reconfiguration is required. However, the traffic in the global communication network is becoming more dynamic as Internet-based traffic becomes more dominating. Therefore the wavelength reconfigurability is required for the next generation submarine network BU, and optical switch is the key enabling element to build reconfigurable BU. Due to the physical location and environment, the time and effort to repair damages in submarine networks is much greater than in the terrestrial network. It is thus desirable for the optical switches in the BU to have latching feature. This feature can also reduce the power consumption in the BU, which is highly desirable for submarine network equipment.

On the other hand, to achieve high degree of reconfigurability in the BU, wavelength-selective switch (WSS) and/or wavelength blocker (WB) is required. A 1×N WSS is an integrated device that uses a 1:K demultiplexer to separate the input WDM signals into K individual channels (K is typically 40 to 100, depending on the channel spacing the operation spectrum range), and uses an array of K 1×N optical switches to switch each channel respectively to one of the N output ports, and then uses N K:1 multiplexers to combine all the channels for each output port [ATFO04]. Besides switching, the WSS also sets attenuation to each WDM channel. A WB is essentially a 1×1 WSS. Despite having large number of optical elements, WSS and WB can be made quite compact because of high density component technologies, such as micro-electrical-mechanical system (MEMS), liquid crystal (LC) array, liquid crystal on silicon (LCoS) and DLP, and the high level of integration.

There are existing technologies that offer latching features for optical switches. These technologies include stepper motor-based, miniature opto-mechanical-based and prism-based switches. However they all require mechanical moving parts, which are more sensitive to vibration and thus have stability issue. For submarine network application, stability requirement is high (again due to the difficulty in undersea fault location and repair). Furthermore, these mechanical switching-based optical switches require relatively large optical and mechanical components (such as prism, glass mirror, and stepper motor), only low port count switches (such as 1×1 on-off optical switch and 1×2 optical switch) are available. In other words, we cannot build such high port count, high integration level device such as WSS and WB using existing latching switch technologies.

Fiber optic network is the backbone of modern communication systems. It provides high capacity link among continents, countries, cities, buildings, and even rooms. Wavelength division multiplexing (WDM) is a common technology used in optical network to increase the capacity within a fiber. By using multiple optical channels with different wavelengths to carry different signals simultaneously, the bandwidth of the each fiber is multiplied. Since not all these WDM channels are going from the same source to the same destination, optical switching is required to add, drop or redirect individual WDM channels. In the past decade, the optical switching node evolved from fixed optical add/drop multiplexer (OADM) to multi-degree reconfigurable optical add/drop multiplexer (ROADM) with advanced features such as colorless, directionless, contentionless, gridless switching [1, 2]. The ROADM allows flexible switching configuration for each WDM channel.

Even though the ROADM function can be achieved by using discrete components, such as in the earlier demultiplexer-switch-multiplexer-based ROADM designs [3], the development of wavelength blocker (WB) and wavelength-selective switch (WSS) made the ROADM more feasible for practical usage. As illustrated in FIG. 1, a 1×N WSS is basically an integrated device that uses a 1:K demultiplexer to separate the input WDM signals into K individual channels (K is typically 40 to 100, depending on the channel spacing the operation spectrum range), and uses an array of K 1□N optical switches to switch each channel respectively to one of the N output ports, and then uses N K:1 multiplexers to combine all the channels for each output port [3]. Besides switching, the WSS also sets attenuation to each WDM channel. A WB is essentially a 1×1 WSS. With various high density component technologies and the high level of integration, the WSS can be made in compact form factors that are suitable for accommodating in optical networking equipment packages. Therefore WSS (including WB, same for the remaining report) is an important component in the latest optical switching products for terrestrial optical networks.

For the submarine network, the switching nodes are called branching units (BU). They split the signal between the main trunk and the branch path and vice versa (FIG. 2). This allows the signals from different paths to share the same fiber, instead of installing dedicate fiber pairs for each link. The signal splitting and combining function of the BU is usually performed optically, therefore the BU has the similar function as the optical add/drop multiplexer (OADM) in the terrestrial WDM networks.

Conventional BU and the submarine network have fixed, pre-determined wavelength arrangement, therefore no reconfiguration is required. However, the traffic in the global communication network is becoming more dynamic as Internet-based traffic becomes more dominating. Therefore, the wavelength reconfigurability is required for the next generation submarine network, with reconfigurable BU as the key enabling element.

Various reconfigurable BU architectures have been proposed. However, there is one critical issue with the existing WSS products in the market, namely the lacking of latching function. The latching function means that the switches will maintain their switching setting even after the power is turned off or cut. For undersea equipment such as submarine network BU, the reliability requirement is much higher than in terrestrial networks due to the physical location and environment, as well as the corresponding required time and effort to repair damages. Therefore, a latching feature is highly desirable. This feature can also reduce the power consumption in the BU, which is another important requirement for submarine network equipment.

Accordingly, there is a need for a latching WSS/WB the can be used in reconfigurable BU in submarine network, that overcomes the shortcomings of prior efforts.

### BRIEF SUMMARY OF THE INVENTION

The present invention is directed to a method for a reconfigurable branching unit BU for a submarine network using bistable liquid crystal BLC optical switching including configuring a submarine network with a branching unit BU for splitting or combining a signal between a main trunk path and a branch path for allowing signals from different paths to share a same fiber optic path, said BU and submarine network normally having a fixed and predetermined wavelength arrangement preventing reconfigurability of the submarine network, and employing a latching wavelength selective switch WSS or wavelength blocker WB in the branching unit for splitting or combining the signals between the main trunk path and branch path to enable a latching capability and enable reconfigurability of the branching unit BU, the latching WSSS being a bistable liquid crystal based material without moving parts for increased stability and lower power consumption over use of conventional mono-stable liquid crystal LC switches in a submarine network.

In an alternative expression of the invention, a submarine network with a reconfigurable branching unit BU using bistable liquid crystal BLC optical switching includes a submarine network with a branching unit BU for splitting or combining a signal between a main trunk path and a branch path for allowing signals from different paths to share a same fiber optic path, said BU and submarine network normally having a fixed and predetermined wavelength arrangement preventing reconfigurability of the submarine network, and a latching wavelength selective switch WSS or wavelength blocker WB in the branching unit for splitting or combining the signals between the main trunk path and branch path to enable a latching capability and enable reconfigurability of the branching unit BU, the latching WSSS being a bistable liquid crystal based material without moving parts for increased stability and lower power consumption over use of conventional mono-stable liquid crystal LC switches in a submarine network.

These and other advantages of the invention will be apparent to those of ordinary skill in the art by reference to the following detailed description and the accompanying drawings.

### BRIEF DESCRIPTION OF THE DRAWINGS

FIG. 1 is diagram of a 1×N wavelength-selective switch WSS;

FIG. 2 is a diagram of a submarine communication system;

FIG. 3 is a diagram showing liquid-crystal LC based WSSs (a) reflective type and b) transmissive type;

FIG. 4 is a diagram of a bistable PSCT switch array;

FIG. 5 is a diagram showing transmittance as a function of wavelength of the PSCT visible light shutter;

FIG. 6 is a diagram is a diagram of a bistable TN optical switch;

FIG. 7 is a diagram of transmission spectra of the bistable TN liquid crystal display; and

FIG. 8 is a diagram of an inventive WSS-based reconfigurable branching unit BU architecture in a submarine network.

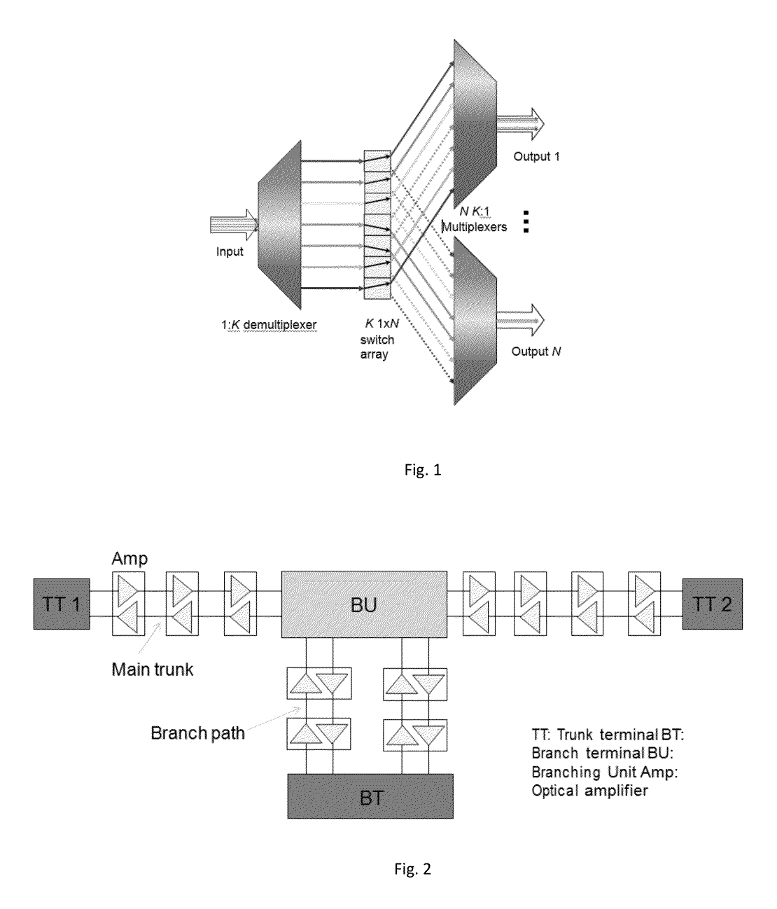

### DETAILED DESCRIPTION

The present invention is directed to a new type of optical switch that can offer latching capability while having compact size. It is based on a bistable liquid crystal (BLC) material, such as the scattering based BLC and the optical retardation based BLC. It replaces the existing mono-stable liquid crystal (MLC) in reflective type or transmissive type LC-based WSS/WB, therefore the latching WSS/WB can be built with the same form factor as the conventional non-latching WSS/WB. Since the BLC does not have physical moving parts, the stability is high.

This BLC-based latching WSS/WB can be used in a reconfigurable BU in submarine network. For the first time, the reconfigurable BU can have both the high integration switching feature (i.e. using WSS and/or WB) and the latching feature. Therefore it can offer both high level of re-configurability and high level of reliability. Power consumption can also be lowered.

Herein, are discussed two techniques to realize the latching feature in a WSS. They are both based on liquid crystal (LC) platform. By enabling bi-stable states in the LC-based optical switches, the switching state can be maintained even when the electrical power is off. These technologies make a highly reconfigurable BU feasible.

In the past decade, the development of WSS has progressed from initial proof-of-concept prototype to mature mass-produced device. The current switching technologies for WSS include micro-electrical mechanical system (MEMS) mirror arrays (which further include single dimension array of MEMS reflective planar mirror elements, and two dimension micro-MEMS reflector mirrors such as DLP switch), liquid crystal on silicon (LCoS) phased array beam steering, and LC-based polarization beam deflection. Compared to other WSS, LC do not have mechanical moving parts, therefore it offers better reliability, more compact footprint, as well as lower energy consumption feature.

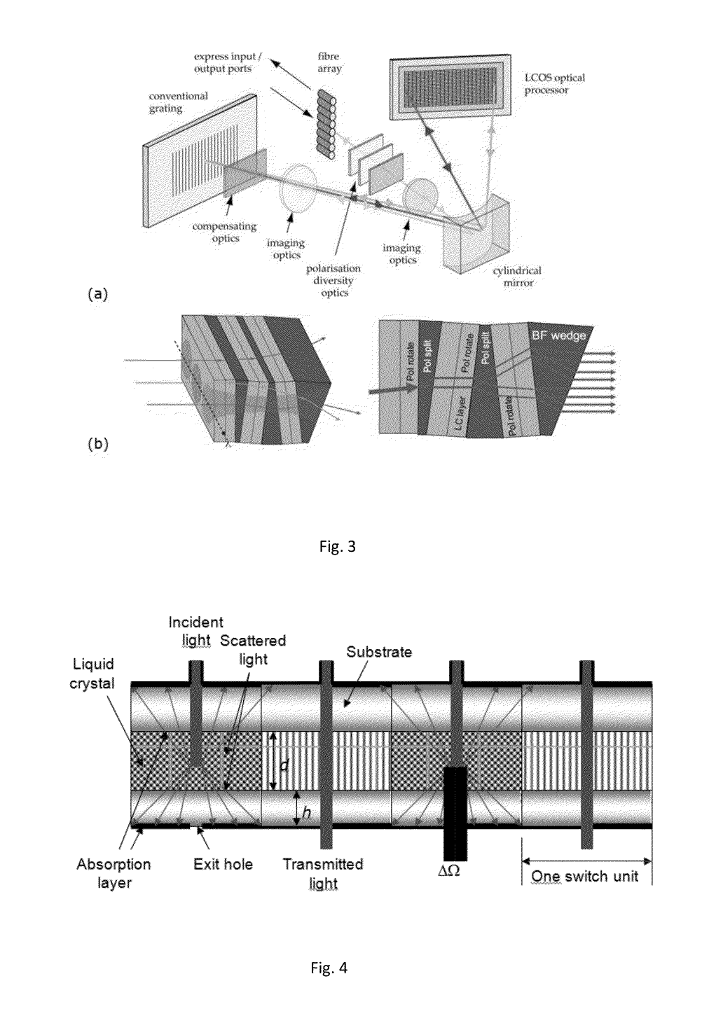

There are two major types of LC-based WSS design, namely the reflective type and the transmissive type. In the reflective type WSS, the dispersed WDM signal is projected to a reflective LC switch array, such as a Liquid Crystal on Silicon (LCoS) optical processor array (FIG. 3(a)), which controls the phase of light at each pixel to perform functions such as beam-steering, attenuation and power splitting [4]. The advantages of reflective type design include: much smaller footprint, lower part count due to the utilization of the same components for demultiplexing and multiplexing the optical signals, self-aligning, and better extinction ratio and doubled maximum steering angle due to double pass [5].

In the transmissive type WSS, the light is switched through a binary LC switching engine, which is comprised of a stack of consecutive pairs of LC cells and polarization splitting elements. Each pair of LC cell and polarization splitting element provides a 1×2 switching functionality. Therefore a cascade of N pairs results in a 1×2N switch (FIG. 3(b)) [6].

The state-of-the-art LC optical switches are mono-stable: they are in the open (or close) state in the absence of an applied voltage and become close (or open) when a voltage is applied. In the case of power failure, they return to the voltage-off state and no longer operate properly. In other words, they do not have latching capability, similar to other WSS technologies. However, among all the WSS technologies, LC is the most likely candidate to offer latching capability because it is possible to design LC to have bistable states. In fact, bistable LC material has been proposed and developed for non-telecom application such as display for portable information systems [7-12]. There are two common classes of bistable reflective display technologies, one is those based on electrophoretic particles [7, 8], and the other is those based on cholesteric liquid crystals [9, 10]. Recently there has been research on another type that is based on the laser-induced absorption of azo dye-doped LC material, which can be switched by changing the direction of linear polarization of a laser beam or by irradiating with nonpolarized UV and visible light [11, 12]. Some of these technologies can be adopted in optical switching for telecommunication applications, such as in WSS. In the following sections, two bistable LC-based optical switch technologies will be discussed.

The first proposed technology is based on a bistable polymer stabilized cholesteric texture (PSCT) switchable light shutter invented by Liquid Crystal Institute in Kent State University [13, 14]. It has two bistable states in the absence of a voltage: the scattering focal conic texture and transparent homeotropic texture. It can be switched between the two stable states by a short time interval voltage pulse. The used LC material exhibits dual dielectric anisotropies. Under a low frequency AC electric field, the LC has a positive dielectric anisotropy and tends to be aligned parallel to the applied field. Under a high frequency AC electric field, the LC has a negative dielectric anisotropy and tends to be aligned perpendicular to the applied field. Therefore a low frequency voltage pulse switches the material from the scattering (close) state to the transparent (open) state while a high frequency pulse switches the material from the open state to the close state.

The optical switch array is schematically shown in FIG. 4. The PSCT material is sandwiched between two parallel glass substrates. The substrates have ITO (Indium tin oxide) coating as the transparent electrode, through which voltages can be applied across the material. When the PSCT material is in the transparent state, light passed through it. The transmittance is close to 90%. When the PSCT material is in the scattering state, light is scattered with very little light passing through it.

The contrast ratio can be estimated in the following way. For simplicity, it is assumed light scattered in all direction uniformly. The area of one switch unit is A (typically ˜1 mm²). The area of the cross section of the incident light is a (typically ˜100 μm²). The cell thickness is d (typically ˜10 μm). The thickness of the glass substrate is h (typically ˜1 mm). The contrast ratio between the scattering state and transparent state is given by

CR=ΔΩ/2π (1)

where ΔΩ is the solid angle of the exit hole and 2π radian is the solid angle coving all direction. When a<<A,

ΔΩ=4π·a/[4π(h+d/2)²]=100 μm²/10⁶ μm²=10⁻⁴ radian

Therefore the contrast ratio is CR=10⁻⁴/2π=1:10⁵, namely, 50 dB.

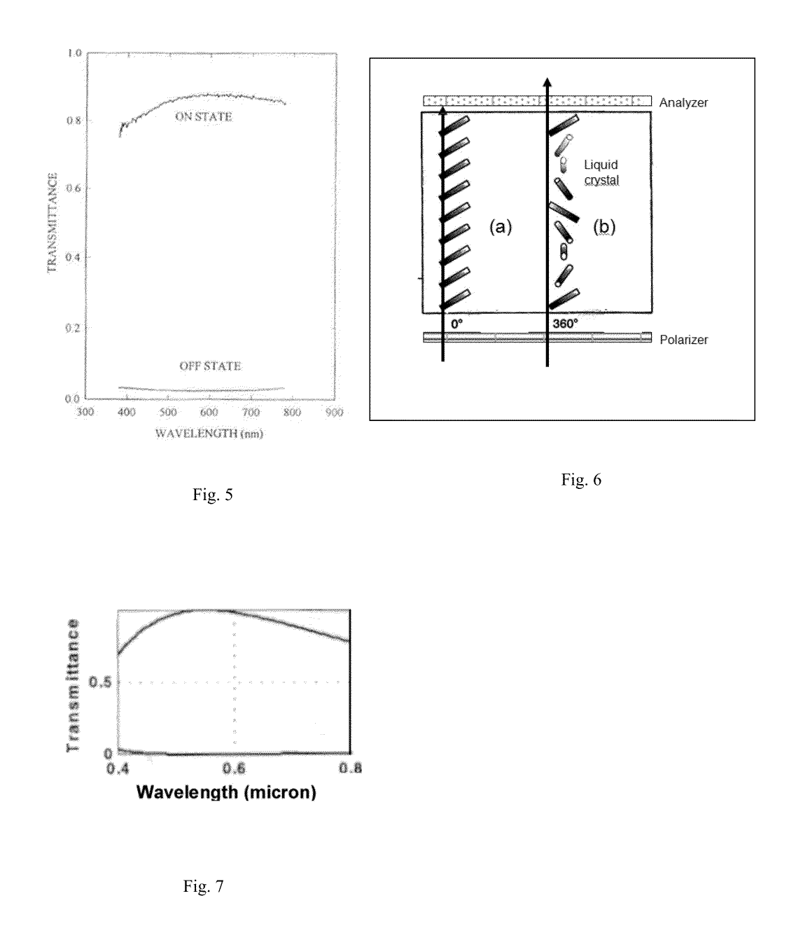

The wavelength dependence of the transmittance of a PSCT visible light shutter is investigated. The result is shown in FIG. 5. The scattering is optimized for visible light. It can be seen that the transmittance changes very little in 100 nm region. The same property can be expected for optical switch working in the common WDM transmission spectrum from 1520 nm to 1630 nm. When the temperature changes, the birefringence Δn is expected to change less than 5%. The transmittance of the open (transparent) state will not change. The scattering is proportional to (Δn)². The transmittance of the close (scattering) state is expected to change by [1.0²−(1.0−0.05)²]/(1.0²)=0.097=9.7%. The contrast ratio will change to 1:(0.923×10⁵), which is still acceptable.

Another technology for LC bistable optical switch is to use bistable liquid crystal light shutters based on modulation of optical retardation [15]. They use polarizer and analyzer. In one of the bistable optical states, the optical retardation angle is φ₁=2πΔn_{eff 1}d/λₒ=2 mπ, where Δn_{eff 1} is the effective birefringence, d is the cell thickness, λₒ is the wavelength of the incident light and m is an integer. The polarization of the exiting light is parallel to that of the incident light. If the polarizer and analyzer are orthogonal, the exiting light is absorbed by the analyzer and transmittance is 0%. In the other bistable optical state, the optical retardation angle is φ₂=2 πΔn_{eff 2}d/λ=(2m±1)π, where Δn_{eff 2} is the effective birefringence. the exiting light is perpendicular to that of the incident light. The transmittance is 100%.

In order to select the right bistable light shutter, we estimate the change of the contrast ratio when the birefringence changes (due to temperature change) or when the wavelength of the incident light changes. The contrast ratio is mainly determined by the transmittance of the close state, which is approximately given by

$${T}_{close} = {T}_{1} = {sin}^{2} ( \frac{{φ}_{1}}{2} ) \qquad ( 2 )$$

When φ₁=2 mπ, T_{close}=T₁=sin²(mπ)=0, When φ₁ changes by Δφ₁ (a small value), the change of the transmittance is given by

ΔT_{close}=sin²(mπ÷Δφ₁/2)=sin²(Δφ₁)≈(Δφ₁/2)² (3)

For example, when λ changes from λₒ=1550 nm to 1600 nm. the change of the optical retardation angle is

$$Δ {φ}_{1} = \frac{2 π {n}_{eff 1} d}{1600} - \frac{2 π {n}_{eff 1} d}{1550} = \frac{2 π {n}_{eff 1} d}{1550} ( \frac{1}{1 + 50 / 1550} - 1 ) = - 2 m π \frac{50}{1550} = - \frac{2 m π}{31} \qquad ( 4 )$$

And the transmittance becomes

ΔT_{close}=(Δφ₁/2)²=(−mπ/31)²=0.01 m² (5)

In order to remain the high contrast ratio when the wavelength is changed or the birefringence is changed, m must be 0. Therefore we can only use the bistable light shutter whose close state has 0 optical retardation. The only possibility for 0 optical retardation is that the liquid crystal is uniformly aligned throughout the LC cell and the angle between the plane of the liquid crystal director and the polarizer is 0°.

Such bistable optical switch can be developed using bistable twisted nematic (TN). The bistable TN has two bistable stables in the absence of a voltage as shown in FIG. 6. One of the bistable states is the 0° twist (untwisted) state as shown in FIG. 6(a), where the liquid crystal is aligned uniformly in the same plane as the polarization of the incident light. The transmittance is 0%. The other bistable is the 360° twist (twisted) state as shown in FIG. 6(b). The transmittance is 100% for properly chosen birefringence and cell thickness. The bistable TN is switched from the untwisted state to the twisted state when a low voltage is applied and then removed. It is switched from the twisted state to the untwisted state when a high voltage is applied and then removed. When a voltage is applied, gray scale transmittance can be obtained.

The transmission spectra of a bistable TN transmissive (visible light) display is shown in FIG. 7. In the untwisted close state, the transmittance is nearly 0% for wavelength within the spectral region longer than 200 nm. It can be expected that this bistable optical switch will have high contrast ratio when the incident light wavelength is varied or the ambient temperature is changed.

Application of Bistable LC in Optical Switching

Both the bistable LC technologies described above can be adopted in WSS to enable latching function. For the reflective type WSS, such as the LCoS-based WSS in FIG. 3(a), the bistable LC material can replace the conventional mono-stable LC material in the reflective mirror substrate. The switching action is still achieved by switching to a phase map that is formed by setting appropriate phase level in each pixel in a 2-D array. But after the switching action is completed, the power can be turned off. The bistable LC in each pixel will maintain the current state, and therefore the switching state of the WSS is held. When the next switching command arrives, the control circuitry becomes active again. It switches off the old phase map and then switches on the new one. After that it is set to inactive state again. This allows very low power consumption. For example, a bistable LC display manufacturer, Lumex, claims that its InfoVue™ bistable LC display technology uses 99% less power than traditional LC displays [15]. And if there is a power outage in the system, the switching state is maintained.

Similarly, for the transmissive type WSS, the conventional mono-stable LC in each 1×2 switching cell is replaced with bistable LC material. The power is only applied when the switching state needs to be changed. Otherwise the switch can maintain the switching state without power, achieving the latching feature.

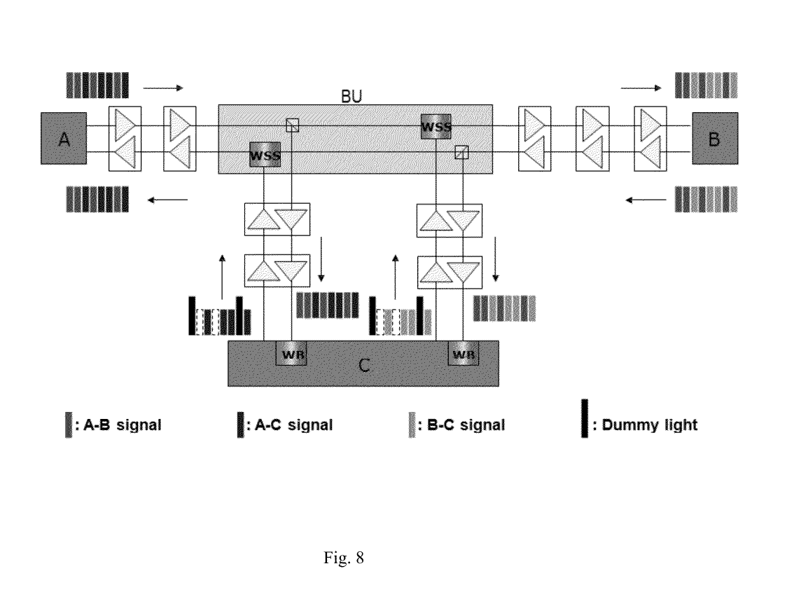

The latching WSS can be used in the WSS-based reconfigurable BU design, such as the one proposed in [4] (FIG. 8). Since the other components in the reconfigurable BU are also passive, the entire BU has latching capability. The reconfigurable BU with bistable LC-based WSS is the first BU that offers full re=configurability and latching capability.

Besides using in the WSS, the bistable LC can also be used in other optical switches in optical communication equipment. However, for lower port switches (such as 1×1 on-off optical switch and 1×2 optical switch), there are existing technologies that offer latching features (such as stepper motor-based, miniature opto-mechanical-based and prism-based switches) [3]. And for higher port count fiber switches (such as 32×32 optical switch and 256×256 optical switch), liquid crystal is not a suitable technology because it cannot perform easy 3-D switching function as the 3-D MEMS technology or the fiber collimator steering technology. Therefore WSS is the most suitable application for bistable LC in optical communications.

The foregoing proposes a novel method to achieve latching function in optical switches. It uses bistable LC to replace the conventional mono-stable LC in the LC-based optical switches. Two bistable LC technologies, namely the scattering based bistable LC and the optical retardation based bistable LC are described. The bistable LC-based optical switch can be used to build WSS and WB with latching capability. This will enable fully reconfigurable yet reliable branching unit in submarine network, because the latching feature helps to avoid traffic interruption and system malfunction in case of power outage. Latching feature also reduces switching power consumption significantly. Therefore the bistable LC-based WSS is a promising solution for next generation submarine network switching equipment.

From the foregoing it can be appreciated that this invention enables latching function in large port count optical switch or optical switching device with high level of integration, such as WSS and WB. The devices based on this technology can offer high reconfigurability while having the benefits of latching operation (such as low energy consumption, stable switching, and immunity to power outage). This invention will make the submarine network more flexible and more reliable. The same latching technology and latching optical switch can also be used in other optical communication and networking equipment to improve reliability and to reduce power consumption.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method for a reconfigurable branching unit BU for a submarine network using bistable liquid crystal BLC optical switching, comprising the steps of:
configuring a submarine network with a branching unit BU for splitting or combining a signal between a main trunk path and a branch path for allowing signals from different paths to share a same fiber optic path, said BU and submarine network normally having a fixed and predetermined wavelength arrangement preventing reconfigurability of the submarine network; and
employing a latching wavelength selective switch WSS or wavelength blocker WB in the branching unit for splitting or combining the signals between the main trunk path and branch path to enable a latching capability and enable reconfigurability of the branching unit BU, the latching WSSS being a bistable liquid crystal based material without moving parts for increased stability and lower power consumption over use of conventional mono-stable liquid crystal LC switches in a submarine network.

2. The method of claim 1, wherein the latching wavelength selective switch comprises a scattering based bistable liquid crystal LC.

3. The method of claim 1, wherein the latching wavelength selective switch comprises an optical retardation based bistable liquid crystal LC.

4. The method of claim 1, wherein the latching WSS or WB comprises a latching capability for avoiding traffic interruption or system malfunction in event of a power outage in the submarine network.

5. The method of claim 1, wherein the step of employing comprises turning off power in the submarine network after a switching action by the latching WSS or WB is completed.

6. The method of claim 1, wherein the bistable LC in each pixel will maintain a current state, and therefore the switching state of the WSS or WB is held and when the next switching command arrives, a control circuitry becomes active again and can switched off an old phase map and then switch on the new phase map and after that it is set to an inactive state again, thus enabling a very low power consumption in the submarine network.

7. A submarine network with a reconfigurable branching unit BU using bistable liquid crystal BLC optical switching comprising:
A submarine network with a branching unit BU for splitting or combining a signal between a main trunk path and a branch path for allowing signals from different paths to share a same fiber optic path, said BU and submarine network normally having a fixed and predetermined wavelength arrangement preventing reconfigurability of the submarine network; and
a latching wavelength selective switch WSS or wavelength blocker WB in the branching unit for splitting or combining the signals between the main trunk path and branch path to enable a latching capability and enable reconfigurability of the branching unit BU, the latching WSSS being a bistable liquid crystal based material without moving parts for increased stability and lower power consumption over use of conventional mono-stable liquid crystal LC switches in a submarine network.

8. The submarine network of claim 7, wherein the latching wavelength selective switch comprises a scattering based bistable liquid crystal LC.

9. The submarine network of claim 7, wherein the latching wavelength selective switch comprises an optical retardation based bistable liquid crystal LC.

10. The submarine network of claim 7, wherein the latching WSS or WB comprises a latching capability for avoiding traffic interruption or system malfunction in event of a power outage in the submarine network.

11. The submarine network of claim 1, wherein the step of employing comprises turning off power in the submarine network after a switching action by the latching WSS or WB is completed.

12. The method of claim 7, wherein the bistable LC in each pixel will maintain a current state, and therefore the switching state of the WSS or WB is held and when the next switching command arrives, a control circuitry becomes active again and can switched off an old phase map and then switch on the new phase map and after that it is set to an inactive state again, thus enabling a very low power consumption in the submarine network.
